(19) United States
(12) Patent Application Publication
(10) Pub. No.: US 2007/0044133 A1
(43) Pub. Date: Feb. 22, 2007

(54) System and method for unlimited channel broadcasting

(76) Inventor: Steven S. Hodecker, Fairfax, VA (US)

Correspondence Address: JACOBSON HOLMAN PLLC, 400 SEVENTH STREET N.W., SUITE 600, WASHINGTON, DC, 20004, US

(21) Appl. No.: 11/504,668

(22) Filed: Aug. 16, 2006

Related U.S. Application Data
(60) Provisional application No. 60/708,762, filed on Aug. 17, 2005.

(51) Int. Cl. H04N 7/173; H04N 7/16; H04H 9/00

(52) U.S. Cl. 725/117; 725/114; 725/16; 725/116; 725/110; 725/109; 725/147

(57) ABSTRACT

A broadband broadcasting system and method that leverages existing commercial-off-the-shelf technologies and service providers to deliver video streaming content to viewers worldwide. First an event is acquired or captured by a digital media broadcast service provider (DMBSP) as “raw” content that is transmitted to an ingest and operations center. The content can be edited prior to ingestion. The ingest and operations center encodes the content for subsequent distribution through a content delivery network, according to the infrastructure of the target network that will ultimately be used to reach end-viewers. Access to the encoded content is available to end-viewers, access is made available to computer-based end-viewers through an interactive and secure portal. The display presented to end viewers is divided into separate frames for main content (the event) and collateral content.

### CROSS-REFERENCE TO RELATED APPLICATIONS

The present patent application is based on, and claims priority from, U.S. provisional Application No. 60/708,762, filed Aug. 17, 2005, which is incorporated herein by reference in its entirety.

### COPYRIGHTED MATERIAL

A portion of the disclosure of this patent document contains material that is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### BACKGROUND OF THE INVENTION

1. Field of the Invention

The present invention relates to unlimited channel broadcasting. More specifically, the invention relates to unlimited channel broadcasting of digital media on either a live or on-demand basis.

2. Related Art

The broadcast and content distribution industry has historically consisted of traditional TV networks, cable networks, local TV stations, cable MSO's, syndicators, satellite TV providers distributing on channel constrained platforms. Content produced and distributed through traditional means has been primarily entertainment, sports, and news maximizing the revenue of each channel.

The advent of widespread networks/networking (Internet, streaming media, corporate, cable, satellite and private nets, etc.) has dramatically expanded horizontal content production and distribution, first to the corporate, financial, education, scientific, medical, and personal/individual sectors, and more recently, to the government sector.

Unfortunately, over the past few years, various hurdles in technology, networks, and cost have severely limited the types of content primarily to fixed words, graphics, and basic animation. Limited bandwidth and penetration of broadband (consumers and enterprises), rudimentary computing devices, technology problems, etc., have curbed the creation and expansion of high-quality, full-motion video and audio content.

In the past, unlimited channel broadcasting companies have suffered from at least five basic limitations: (1) high, fixed costs of building fiber networks (especially last-mile), resulting in high prices for broadband access; (2) end user device limited to the computers only, and computers anchored by wires; (3) poor quality experience due to limited adoption of new technology by public networks (encoding, compression and other online video/audio/data technologies still under-developed, not mature enough to rival traditional broadcast, cable, satellite or radio); (4) not scalable due to poor consumer adoption; and (5) extreme caution of large entertainment and other valuable content providers in producing digital content and deploying in alternative broadcast networks (issues of digital rights management, fear of cannibalizing existing product/services; low return on investment; IP and networking were unfamiliar, unknown worlds; capped-off by the dot.com bust)

More recently, bandwidth has become pervasive. The fiber network building boom, the improvement of DSL, and cable broadband in combination have enabled 80% of the U.S. population to have access to high-speed broadband services (42% growth in penetration in 2003, with 28.2 million high-speed lines in place). Costs have fallen (and continue to fall) dramatically over the past four years due to over-capacity of fiber networks and abundant availability of bandwidth, resulting in lower broadband access prices. IP enabled devices—the television set, wireless technologies (WiFi, fixed-wireless, etc.), 3G mobile phones, affordable laptop computers, converged consumer electronic devices (IP-enabled set-top boxes, PC-TV, IP-enabled TVs, etc.), satellite broadband devices—are affordable and pervasive, un-tethering consumers from the fixed-line desktop.

However, conventional Internet broadcasters have no real control between the point of origin of their broadcast and the viewer. The broadcast thus can take an unlimited number of “hops” between the point of origin and the viewer, which may cause the quality of the video stream to degrade.

It is to the solution of these and other problems that the present invention is directed.

### SUMMARY OF THE INVENTION

It is accordingly a primary object of the present invention to provide unlimited channel live and on-demand broadcasting on a global basis to any device that receives broadband technology.

It is another object of the present invention to provide unlimited channel live and on-demand broadcasting with organization of the content and control of the delivery to the “last-mile” head ends.

It is still another object of the present invention to provide unlimited channel live and on-demand broadcasting in which the content is organized and segregated according to a viewer's profile.

These and other objects are achieved by a broadband broadcasting system and method that leverages existing commercial-off-the-shelf technologies and existing commercial service providers to deliver video streaming content to viewers worldwide.

First an event is acquired or captured by a digital media broadcast service provider (DMBSP) as “raw” content. The DMBSP can dispatch camera and production crews to events to shoot an event for live streaming or archived distribution, or the DMBSP can accept a “feed” from an existing broadcasting source (like a cable channel). “Live” feeds can be edited locally or centrally by the DMBSP and then transmitted back to an ingest and operations center, or the DMBSP can transmit the “raw” content directly to the ingest and operations center. Adding commentary, advertisements, or graphics are typical editing functions that the DMBSP can perform.

The transmissions themselves are made via satellite up-link/down-link, fiber optic cable; or in cases where archived distribution is the only requirement, a physical tape (VHS, Beta, Digicom, etc.) can be delivered. Once the ingest and operations center receives the content, it encodes the content for subsequent distribution through a Content Delivery Network (CDN). The appropriate encoding format, or multiple encoding formats, is selected according to the infrastructure of the target network that will ultimately be used to reach end-viewers. For example, the encoding format and bit-rate would differ for broadcasts to broadband computer-based viewers versus cell phone viewers.

Once the encoded (post-production) content is available to end-viewers, access is made available to computer-based end-viewers through an interactive and secure portal. Viewers make purchase selections through an e-commerce and inventory management graphical user interface of an Online Management System (OMS), also integrated within the portal platform. If viewers require assistance, a help-desk is staffed to navigate them through the registration process and troubleshoot viewing difficulties. Peering relationships with other “last-mile” service providers enables streaming content to be directly “injected” into the head-ends' infrastructure (in contrast to conventional Internet broadcasting methods, which have no control over the number of “hops” or the quality of the infrastructure, including bandwidth availability, that would carry content distributed in this manner). As used herein “last-mile” refers to the final leg of delivering broadband communications connectivity from a telephone company, cable company, or other Internet service provider (ISP) to a customer.

The display presented to end viewers is divided into separate frames or “channels.” The main content (the event) is displayed in a main frame or video streaming channel. Collateral content can be displayed in adjacent I-frame channels (also called portlets). For example, statistics for a football team's players can be made available in an I-frame channel while a game featuring the same team is being broadcast in the adjacent video streaming channel. Many other related topics can be presented in these adjacent portlet channels: school information, advertisements, or even an interactive channel inviting viewers to respond to surveys, chat, or vote for their favorite player. Regardless of the content itself or of the network upon which the content is available, the system and method in accordance with the present invention provides a convergence of a television viewing experience with an interactive computer experience. Viewers can enjoy an interactive e-commerce experience by shopping on-line for items (electronics, textiles, or even household items) at the same time they are watching an event that features those items.

The system and method in accordance with the present invention has the ability to organize and segregate information presented to viewers according to an individual viewer's “role” or “personal profile.” Sex, age, geographic location, and interests are just a few categories upon which the DMBSP can customize and personalize the viewing experience. These capabilities can also be applied to government and corporate networks to offer organizations the ability to control “who gets to see what,” “how much do they get to see,” and “when are they allowed to see it.”

In either commercial consumer or large enterprise applications, the system and method in accordance with the present invention permit personalization and information segregation, enabling viewers to fine-tune their own viewing experience by changing the look-and-feel and selecting the types of content they want displayed and collaborated in a consolidated view, which makes for a much more enjoyable and efficient content consumption experience.

In contrast with conventional Internet broadcasters, which have no real control between the point of origin of their broadcast and the viewer, the present invention provides a system and method for unlimited channel broadcasting that offers organization of the content and control of the delivery from the backbone provider (which is the content delivery network) directly to the last-mile head end service providers, which bring the content much closer to the viewer, shortening the number of hops and improving the quality of the video stream. The present invention further differs from conventional Internet broadcasters in its ability to organize and segregate the content according to a viewer's profile, and then deliver multi-frame content items to the viewer according to his or her personal preferences.

Other objects, features, and advantages of the present invention will be apparent to those skilled in the art upon a reading of this specification including the accompanying drawings.

### BRIEF DESCRIPTION OF THE DRAWINGS

The invention is better understood by reading the following Detailed Description of the Preferred Embodiments with reference to the accompanying drawing figures, in which like reference numerals refer to like elements throughout, and in which:

FIGS. 1A and 1B are examples displays presented to end viewers in accordance with the present invention.

FIG. 2 is a diagram showing the relationship between the participants in accordance with the present invention.

FIGS. 3 and 4 are flow diagrams together illustrating the operational steps in creating an unlimited channel broadcast in accordance with the present invention.

FIG. 4A is a Windows media rights flow diagram of the media services provided by the ingest and operations center shown in FIG. 3.

FIG. 4B is a workflow diagram of the media rights provided by the ingest and operations center shown in FIG. 4.

FIG. 5 is an exemplary viewer storefront in accordance with the present invention.

### DETAILED DESCRIPTION OF THE PREFERRED EMBODIMENTS

In describing preferred embodiments of the present invention illustrated in the drawings, specific terminology is employed for the sake of clarity. However, the invention is not intended to be limited to the specific terminology so selected, and it is to be understood that each specific element includes all technical equivalents that operate in a similar manner to accomplish a similar purpose.

The present invention is described below with reference to flowchart illustrations of methods, apparatus (systems), and computer program products according to an embodiment of the invention. It will be understood that each block of the flowchart illustrations, and combinations of blocks in the flowchart illustrations, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions specified in the flowchart block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function specified in the flowchart block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions specified in the flowchart block or blocks.

The present invention is preferably practiced within a client/server programming environment. As is known by those skilled in this art, client/server is a model for a relationship between two computer programs in which one program, the client, makes a service request from another program, the server, which fulfills the request. Although the client/server model can be used by programs within a single computer, it is more commonly used in a network where computing functions and data can more efficiently be distributed among many client and server programs at different network locations.

As is known to those with skill in this art, client/server environments may include public networks, such as the Internet, and private networks often referred to as “Intranets” and “Extranets.” The term “Internet” shall incorporate the terms “Intranet” and “Extranet” and any references to accessing the Internet shall be understood to mean accessing an Intranet and/or and Extranet, as well. The term “computer network” shall incorporate publicly accessible computer networks and private computer networks.

It is to be understood that the present invention is not limited to the illustrated user interfaces or to the order of the user interfaces described herein. Various types and styles of user interfaces may be used in accordance with the present invention without limitation.

The following abbreviations and acronyms are used herein:

ATM: Asynchronous Transfer Mode

BOSS: Back Office Support System

CDN: Content Delivery Network

CEM: Customer Event Manager

CRM: Customer Relationship Management

DMBSP: Digital Media Broadcasting Service Provider

DRM: Digital Rights Management

DVD: Digital Versatile Disc

HR: Human Resources

ID: User Identification—Username and Password

IE: Internet Explorer

IOC: Initial Operating Capability

MOU: Memorandum of Understanding

MRA: Media Rights Agreement

MS: Microsoft

MSO: Multi-Service Operator

OMS: Online Management Systems

OS: Operating System

PC: Personal Computer

PDA: Personal Digital Assistant

RA: Rights Agreement

UI: User Interface

URL: Uniform Resource Locator

VCD: Video Compact Disc

VPN: Virtual Private Network

WMP: Windows Media Player

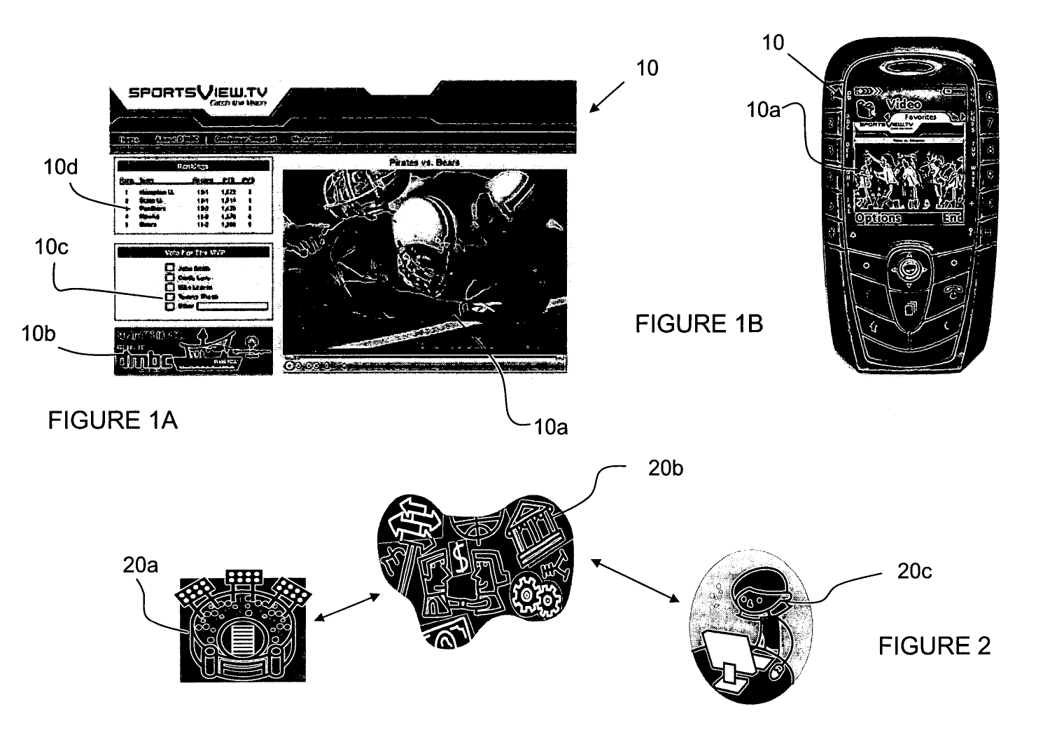

Referring to FIGS. 1A and 1B, the system and method for unlimited channel broadcasting in accordance with the present invention delivers niche digital broadcasts 10 over a dedicated, video enabled network, which enables an unlimited amount of specialized broadcasts to be delivered directly to their target audiences via broadband and wireless technology. The system and method in accordance with the present invention distributes full streaming video live 10a and on-demand, taking content from an event and seamlessly delivering a fully produced broadcast (including advertising insertion) to a viewer, while allowing the viewer to: watch special interest events that otherwise are not broadcast by mass media; choose to watch live or on a completely on-demand basis; order archives on DVD or other storage media; and choose how to receive the broadcast (for example, on computer (as shown in FIG. 1A), television, or next generation wireless phones (as shown in FIG. 1B) and PDAs).

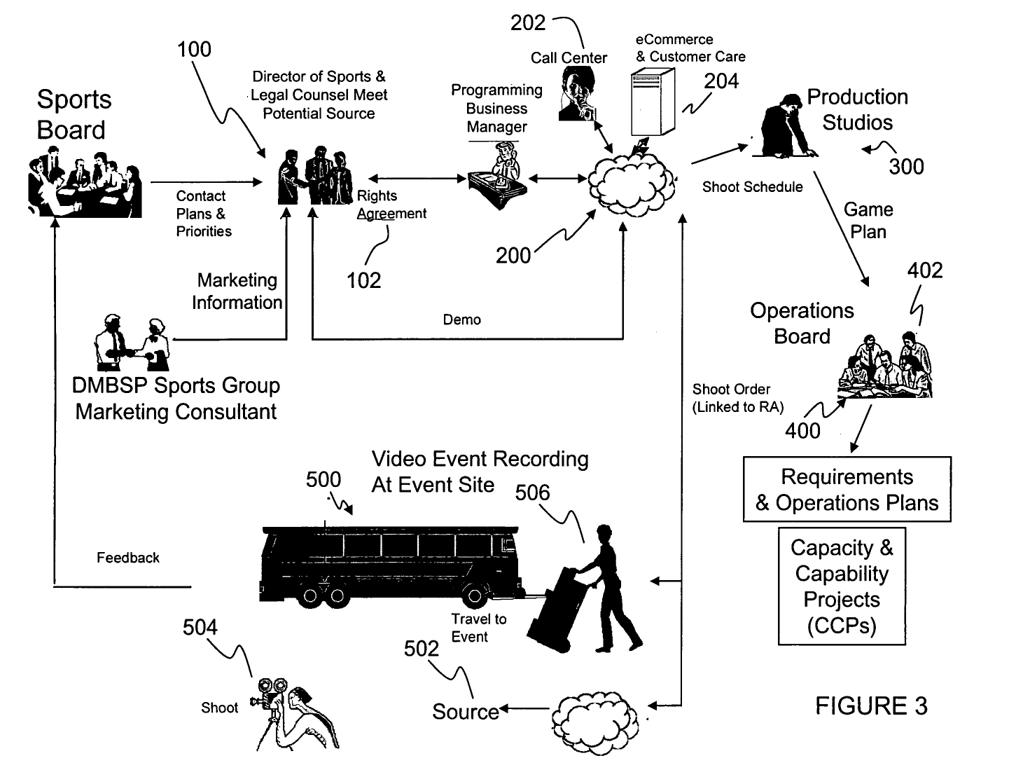

As shown in FIG. 2, the system and method for unlimited channel broadcasting in accordance with the present invention employs three types of participants: at least one media source 20a, a DMBSP 20b, and at least one viewer 20c. Media sources 20a and viewers 20c are collectively referred to herein as “customers.”

The DMBSP 20b is a content owner and provider that provides digital media broadcasting services to targeted audiences of viewers. The content originates with the media source 20a, and can be in a variety of categories including, but not limited to: sports, medicine, education, government, and corporate communications.

The content is targeted to an audience that has specific interests in which there are very few to no conventional media outlets. For example, in the sports category, the DMBSP 20b could focus on NCAA Division III, Division II, and smaller Division I colleges, and high schools, as well as on content with a wide range of international, amateur, and youth sports organizations. Viewers for targeted sports content would include professional and college athletic staff (scouts, coaches, Athletic Directors), parents, relatives, alumni, and fans of events that are not regularly or are never seen on traditional broadcast media. Viewers can choose to watch on computers, TVs with DSL, cable, or other broadband service, and on next generation wireless phones and PDAs.

In addition to content in sports, content in other categories can be targeted. For example, advanced surgical procedures can be broadcast to doctors in a particular field or new product demonstrations can be broadcast to key customer or sales representatives. The DMBSP 20b can also have affiliate partnerships with existing broadcast companies to provide extended broadcasting over its dedicated IP network and distribution channels.

Content is available on a near real time but delayed basis as outlined in the DMBSP's online broadcast schedule. Content is also available on-demand following the event for a limited period of time (for example, 24 hours), and archived event content is available indefinitely. Viewers must have access to a computer with a broadband connection, a cable/satellite TV subscription, or a mobile phone service, to watch the content.

The system and method in accordance with the present invention allow media sources 20a to ensure their events are available and easy to access not only for the casual observer or interested third party, but more importantly, to the professional viewers or potential key decision makers whose decisions may be affected by viewing certain content. The system and method in accordance with the present invention thus allows media sources 20a to capture value indirectly (monetarily or otherwise) through broadcasting events. For example, the service and method in accordance with the present invention permits the professional scout to view players through the DMBSP's sports content, which is not available through existing broadcast media, and permits an alumnus to see how well his university's team is doing (which may persuade him to make a larger donation to his university). As another example, the service and method in accordance with the present invention permits a doctor who is unsure of the benefits of a new piece of equipment to see a live surgical demonstration through a medical collaboration broadcast.

As discussed in greater detail below, in order to deliver the final content to the viewer, the DMBSP 20b captures existing broadcast feeds from local television/cable providers, or deploys its mobile production crew to capture a live event. For major events, the DMBSP 20b can work with television and cable syndications, and major cable and wireless providers to extend the DMBSP's content directly to their customers.

As further discussed in greater detail below, the live feed is transmitted to an ingest and production center, where the live feed is encoded and managed through a post-production facility for broadcast and streaming distribution to a content delivery network. The end result is a broadcasting experience similar to programming seen on regular television, except that the live broadcast is accessible to viewers globally and on any device that receives broadband technology.

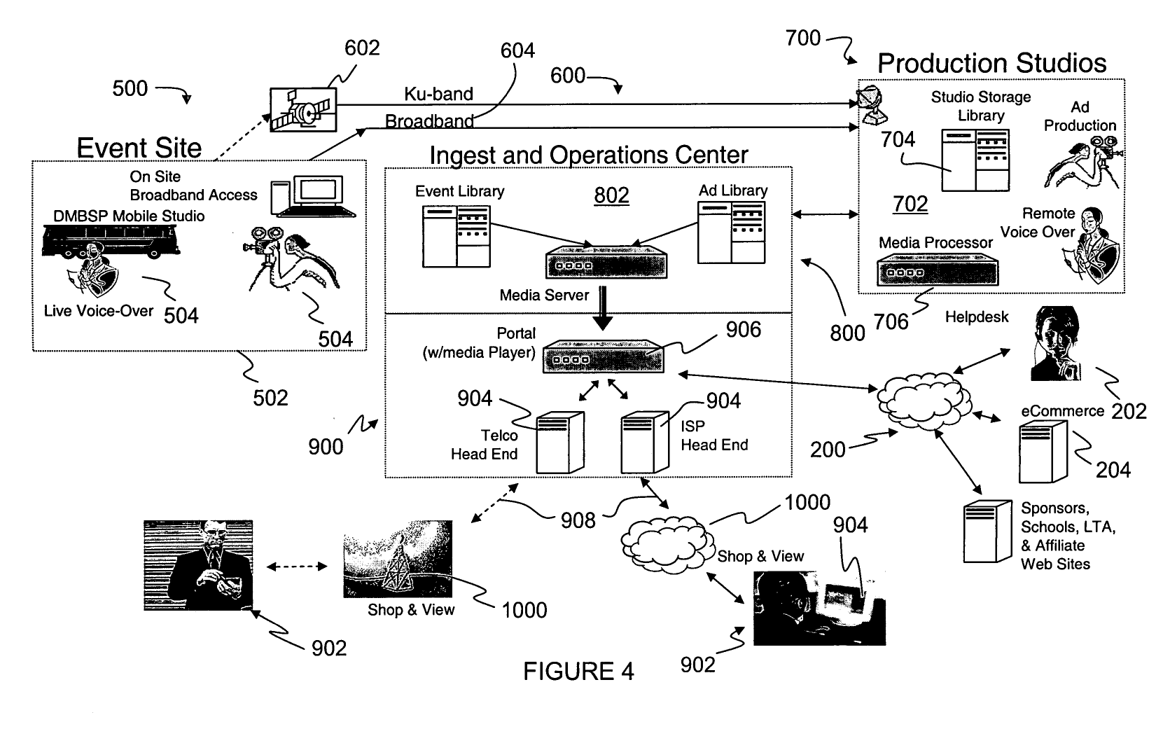

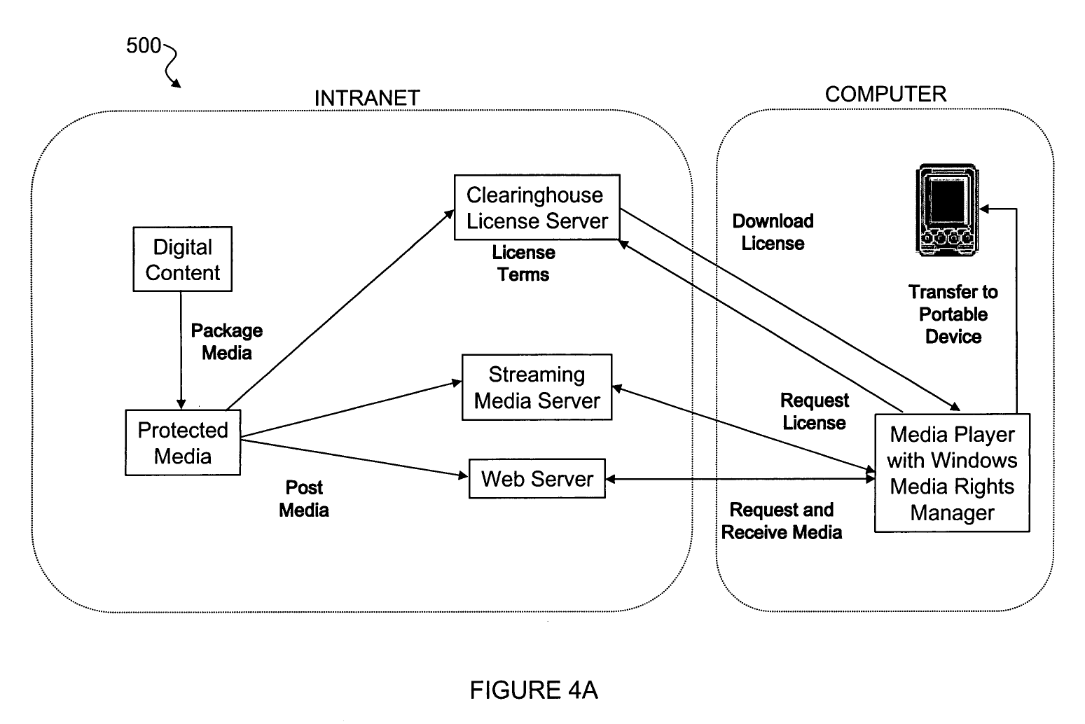

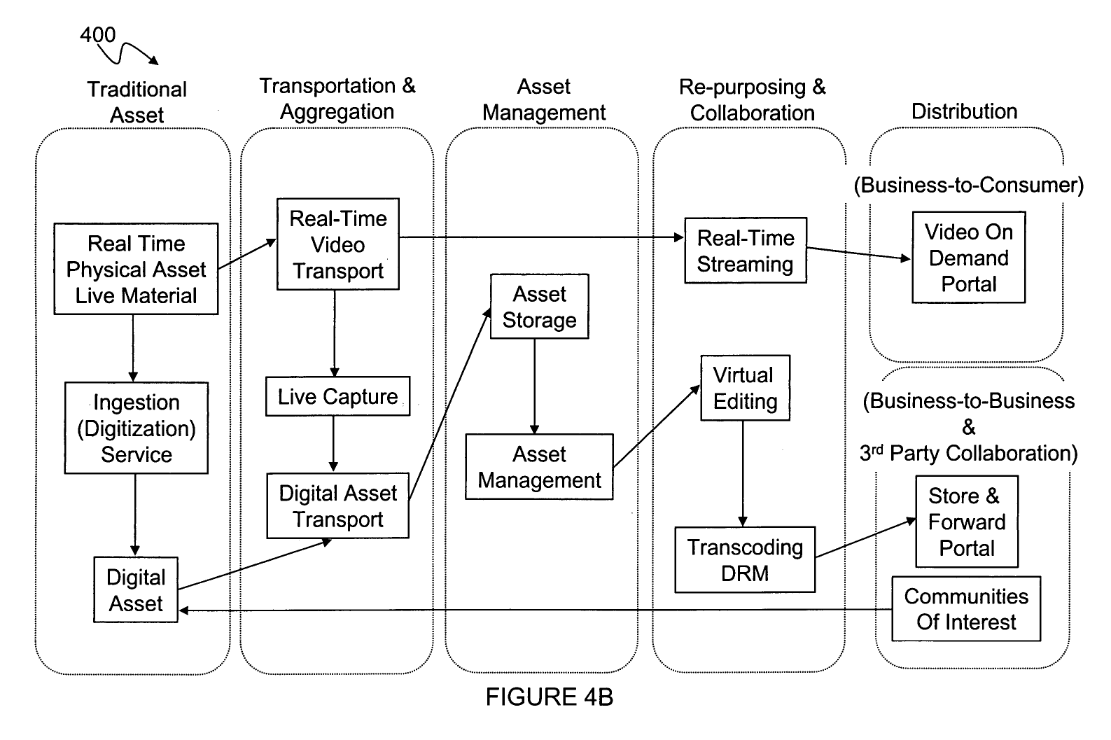

With reference to FIGS. 3 and 4, the creation of an unlimited channel broadcast involves the steps of: (1) obtaining rights agreements for the event to be broadcast (step 100); (2) providing after-market support after rights agreements are signed (step 200); (3) events planning (step 300); (4) managing the technical baseline for the operational (production) system (step 400); (5) event video recording (step 500); (6) event video transmission (step 600); (7) event video production (step 700); (8) event video encoding and streaming (step 800); (9) event video distribution (step 900); and (10) managing the viewer experience (step 1000). These steps will now be described in greater detail.

Step 1—Obtaining Rights Agreements (100)

DMBSP operations are dependent upon rights agreements 102. The DMBSP 20b obtains “Direct Delivery” rights agreements that are different than conventional broadcast rights and Internet rights. A typical rights agreement includes: (1) event type (sports, medical, education, etc.); (2) organization, releasing authority, and contact information; (3) effective dates, including exclusions; (4) scope (number of events); (5) permissions (what events); (6) blackouts or distribution restrictions; (7) advertising rights and restrictions; (8) cost model; (9) recording specifications (audio and video quality control); and target audience lists (email, bulk mail, etc.).

Step 2—Providing After-Market Support (Customer Care) (200)

Customer service representatives provide after-market support to media sources 20a after rights agreements are signed. Additionally, customer service enables both media sources 20a and viewers 20c to manage their accounts using an online customer care (e-commerce) engine 204. Media sources 20a are able to access their rights agreement database and their broadcast history, as well as a wide range of purchase and subscription histories. Likewise, viewers 20c are able to use the online systems to shop for, purchase, and track their viewings. Both media sources 20a and viewers 20c have access to a call center 202 that operates to resolve issues or concerns.

Step 3—Events Planning (300)

Media sources 20a can request special event broadcasting for special interest events in additional to the events covered by their rights agreement. Likewise, media sources 20a can make special production requests for highlight videos, scouting reports, and other unique products that leverage the broadcast.

The DMBSP production staff includes production schedulers, trainers, and studio technicians, as well as crews. The production schedulers are responsible for planning, resolving ad conflicts, and scheduling crews to record all events. The production scheduler issues shoot orders to either a media source's in-house crew or DMBSP crew. On occasion, the scheduler issues a joint or co-op shoot order. When necessary, the production scheduler can issue shoot orders to third party production houses to support high/peak workloads. In all cases, the shoot orders include quality specifications that are consistent with the quality specifications outlined in the rights agreement.

The shoot orders are issued in compliance with the rights agreements. In the case of shoot orders issued to existing media sources' in-house crew or production staff, the media sources 20a simply provide access to their existing content or feed it to the DMBSP's event ingest system according to the directions contained in the shoot order. Additionally, the shoot orders include specific instructions that outline regulatory, NCAA compliance, or other special instructions for the recording crews. The event scheduling shoot orders are managed by the automated e-commerce engine 204.

A DMBSP production scheduler plans, coordinates, and issues orders to the production crews to create and release special purchases such as athletic and event documentaries. Examples of such documentaries include:

Athlete Documentary—The production studio 702 provides specialized documentary broadcasts that focus on a designated athlete or team. These documentaries may cover multiple events and include highlighting and off-the-field interviews; and include third person discussions with coaches and opponents, as well as integrated statistical performance data; and address the whole person by including sports psychology, academic, and health profiles. Similar products can be produced for a designated doctor or medical team, perhaps a university research graduate. These documentary products typically highlight a person or small group of people and/or a team for scouting, marketing, or promotional purposes.

Event Documentary—The DMBSP 20b provides specialized and in-depth coverage of designated events such as a week-long soccer tournament or professional sports camp. A similar documentary product can be produced for an industry seminar or corporate board of directors meeting.

Step 4—Managing The Technical Baseline (Operations Board) (400)

The DMBSP 20b has an operations board 402 that convenes regularly (for example, weekly) to manage the technical baseline for the operational (production) system. The board governs the baseline and all changes to the recording, transmission, ingestion, editing, storage, streaming, portal, and distribution architecture, including all equipment and software components.

Step 5—Event Video Recording (500)

Examples of different types of content in the sports category include:

Live Game Broadcasts: Live broadcasts can be viewed world-wide in real-time, or the viewer 20c can choose to watch the event delayed up to 24 hours to suit his or her schedule. Live event “tickets” give access to both options, giving more flexibility to the viewer 20c.

On-Demand Event Library: Tournaments and championship games are available on-demand from the DMBSP 20b for an extended period of time. In addition, the on-demand event library includes international and specialty events that had limited, live broadcast elsewhere.

Coach's Shows and Documentaries: Coach's Shows and Documentaries are available from the DMBSP 20b on-demand, allowing the viewer 20c to keep informed of his or her favorite team.

On-Demand Training Videos: Training and instructional videos are available to the viewer 20c on-demand from the DMBSP 20b in the Training Library.

Training and Event Archive DVDs: Season archives, training videos, and other DVD collections are available from the DMBSP 20b.

The media sources 20a for many events have existing recording capabilities. For example, most high schools and colleges have crews that “record” their events to meet conference exchange requirements. Likewise many corporations, government agencies, industrial associations, and educational institutions already have in-house recording teams with access to studios. Where needed, the DMBSP 20b deploys crews to record events for organizations or events where the media sources 20a do not have recording capabilities. In all cases, DMBSP support teams are used to assist with capturing quality event content for DMBSP broadcasting.

Step 6—Event Video Transmission (600)

Once the event is recorded, there are multiple ways to transmit the content to the DMBSP production studio 702. Possible methods include, but are not limited to mobile or stationary satellite uplinks 602 and broadband 604. The raw footage is then transmitted from the source to a production studio 702 for editing.

Step 7—Event Video Production (700)

All raw event data streams are captured at the production studio 702. The events are ingested into a studio storage library 704 where each event is staged for processing. Each event is processed using online editors 706 to eliminate lulls; insert header and trailer; insert ads; overlay graphics, scores, and/or bugs; and overlay voice and play-by-play commentary.

Step 8—Event Video Encoding and Streaming (800)

The uncompressed but processed video in digital (MPEG 4) format is sent by the production studio 702 to an ingest and operations center 802, where the video is archived, encoded, and encrypted for distribution via DVD/VCD or streaming video to the viewer 20c. The product stored at the ingest and operations center 802 is considered the final version of the event file(s).

Additionally, all content ingested into the ingest and operations center 802 is protected using conventional DRM technologies. Upon a one-time payment, viewers 20c are authorized to access content as often or as many times as they want, and to transfer the content to their computer once. If additional transfers are needed, customer service can support a customer's need with a one-time transfer or by providing a DVD or the like.

Step 9—Event Video Distribution (900)

Once the event video is processed it is distributed using two methods, streaming video 904 and DVD/VCD. In the case of DVD/VCD, the DVD/VCD is created from the archived video database and shipped to the viewer 20c. In the case of streaming video 904, the video is translated to the appropriate protocol and distributed from the ingest and operations center 802 to its virtual head-ends 904 where the portal 906 (that is, the web site viewed by the customer) resides and is distributed to wireless, broadband, CATV, etc. service providers. The service providers then distribute the portal 906 and the streaming video 904 to the viewer's broadband device (i.e., computer, mobile phone, etc.).

The viewer experience is provided through a secure portal 906 that provides single, integrated view of media surrounded by relevant content. The viewer portal 906 performs the following functions: integrates the primary media stream with other streams and/or static content; integrates disparate user interfaces such as media selection, video display, customer service, advertising, and e-commerce into a single portal presentation; and provides a platform for coordinated user activities across several applications.

The viewer portal 906 also has the following characteristics: a display customizable down to the individual viewer, role, or domain; a single sign-on login to multiple applications, requiring no custom software development or modification to back-end applications; a Content Retrieval System that enables dynamic modification of content and carefully controls what is displayed to both customers and administrative users; security controls that can restrict access to content based on user, role, and/or domain; proxy technology that ensures that private network IP addresses, ports, and media licenses remain hidden from all external users (including, but not limited to, customers), with the network proxy providing real-time content filtering and modification; XML binding layer and Java API that offer a framework for rapid development; tiered model of Web Server, JSP engine, and portal server provides redundancy, scalability, and fail-over support; configuration and business objects stored in an open, standard relational database; vendor and application independence with regard to platform, browser and, integrated applications for maximum flexibility; and distributed, standards-based architecture—Java, JSPs, servlets, CORBA/RMI, XML.

The integrated media stream exiting the portal 906 is distributed via an Intelligent IP Networking service, in which virtual routers are deployed around the world to provide the “Intelligent IP” routing and other network-based VPN functionality. The network is fully redundant on its backbone, its PoPs, and its local loops. It is designed with ATM as the backbone switching architecture, which allows the delivery of high site-to-site performance.

Step 10—Managing The Viewer Experience (1000)

A primary object of the system and method in accordance with the present invention is to connect the broadcast with the intended audience and viewer. In order to achieve this object, once a viewer 20c is registered with the DMBSP 20b and has purchased events, the viewer 20c receives an email or hardcopy invitation to register for an upcoming event of interest. Invitations target a specific audience and direct viewers 20c to the DMBSP's website and provide viewer registration guidance.

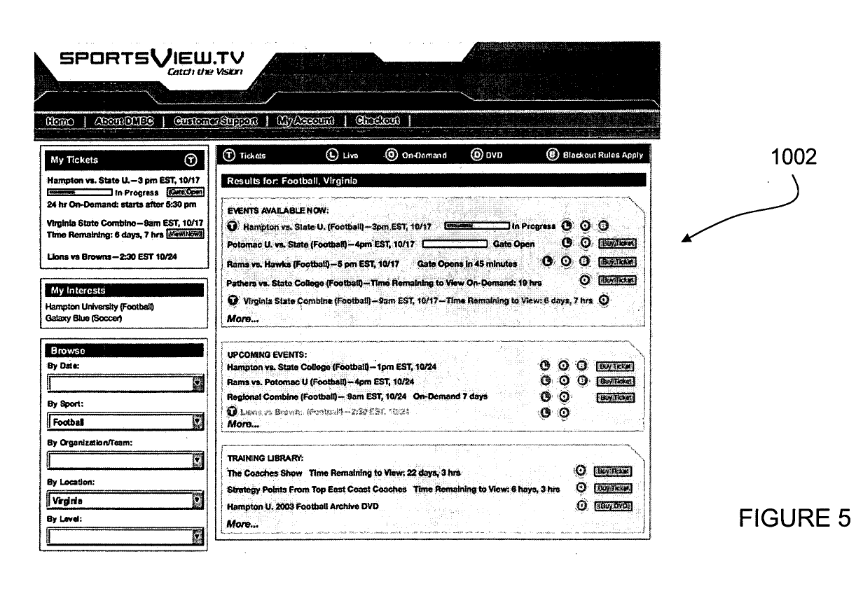

Once registered with a viewer account, viewers 20c logon to the website and initially start at a “shopping” page or storefront 1002 (FIG. 5). The shopping page is the viewer's interface to the DMBSP e-commerce engine, which allows viewers 20c to use a search tool or peruse event previews organized by topic to order events online. The events can be ordered on a pay-per-view or subscription basis. Additionally, a viewer 20c can visit a shopping tool that highlights designated events or that directs the viewer 20c to designated events based upon his or her logon. The shopping experience is carried out through a conventional web shopping application that includes a shopping cart, credit card payment, and viewer account management.

In order to provide unlimited channel live and on-demand broadcasting on a global basis to any device that receives broadband technology, the system and method in accordance with the present invention supports seven different functionalities: media rights management, production, e-commerce, advertising, customer service, delivery, and BOSS.

The media rights management functionality encompasses rights agreements and blackouts. In order to access content, the DMBSP 20b obtains exclusive rights agreements with a variety of media sources 20a, as described above. Additionally, the DMBSP can establish rights agreements with existing broadcast companies to provided extended broadcast services to these affiliate partners.

A media rights UI in the portal supports full creation and editing of events and rights agreements by a DMBSP Sales Executive, or another person authorized to negotiate Rights Agreements. This “portal” is the application portal that all viewers and DMBSP staff use to access/submit information. There are various interfaces for each user type (and level). For example, administrative portal users would have rights to edit access privileges for regular viewer users.

The Agreement viewer/editor displays the following data for an Agreement: Organizations, Dates, Contact Information, Terms, Distribution Rights, Revenue Sharing Breakdowns, and Covered Events. All events are linked in the system to a Rights Agreement. A client ID number unique to each media source 20a can be used to aggregate multiple Rights Agreements together for reporting and accounting purposes.

Sales executive users can populate a list of all MRA's or selected MRA's based on the following search criteria: Expiration date, Institution, Institution location, Contact name, and No Selection (complete listing).

Viewing a Media Rights Agreement presents to the administrative user a form with the following functional categories:

General information (including participating organizations, formalization date, agreement references, agreement name, and an MRA history (via a button)—history items can be viewed in detail through a link such as a “view” button, and all applicable attachments can be opened via a link such as a “get” button.

Releasing authorities—sales executive users can open and select from a list of contacts as well as create, edit, and view these contacts.

Term of agreement—the term of each agreement can be changed or updated by authorized sales executive users (using a calendar button).

Distribution rights—sales executive users can view and edit AIR, CABLE, IP, and PHYSICAL pages via a link such as a “view” button under the Distribution Rights section of the MRA.

Revenue sharing—sales executive users can manually input revenue source percentages.

Events covered by the agreement—a sales executive user or a production administrator user can view, edit, and delete items shown in the pre-existing list of events as well as add new events

The media rights UI in the portal also supports entry of blackout rules to be associated with events. A blackout term indicates how long the blackout is in effect after the start time of the broadcast. Blackout restrictions are determined by zip code (billing zip code). Zip codes are obtained and/or verified from viewer profile information and credit card billing information. Customer service representatives have a “back door” through the OMS administrative interface to override blackout restriction for a particular viewer 20c for a particular event.

The production portion of the system and method in accordance with the present invention encompasses event administration (creation and management), event scheduling, event encoding, event distribution, event storage, studio, capacity, and video preparation functionalities.

Event administration refers to the actual management of the events in the active inventory (on-demand, live, training, etc.)—including making the list of events available to public consumers, establishing date ranges for the availability of events, etc. Event administration includes creation of inventory, population of a list of all events, and input of criteria. Inventory is created via an administrative user interface in the portal. The system automatically makes new events and packages available to the e-commerce inventory.

System administrator users or event production administrator users can populate a list of all events based on the following search criteria: Expiration date, Institution, Institution location, Contact name, and No Selection (complete listing). Administrative users can input criteria in the following pages: Description, Consumption, Production, Archive, Rights, and Attachments.

A UI in the portal supports full creation and editing of events and basic associated data such as date/time, location, teams, pricing, satellite information, sales representatives, and broadcast URL. This “portal” is the application portal that all viewers and administrative staff use to access/submit information. There are various interfaces for each user type (and level). For example, administrative portal users would have rights to edit access privileges for regular viewer users.

An event viewer/editor in the UI allows unlimited display of meta-data associated with that event. A document attachment utility enables production documents to be attached to an event.

Detailed data regarding event scheduling and production is managed by the Production Coordinator in a stand-alone application. Each event has a Customer Event Manager (CEM). The CEM enters all of the appropriate information about the event and activates a switch in the User Interface to formalize an event once it has cleared the approval process. The event URLs are automatically known to all system components by convention. The CEM notifies all appropriate parties, including the Production Manager and the production studio 702, of the approved event via an established e-mail process. The Production Manager is responsible for all activities related to planning, shooting, and transmitting the event.

Feeds are sent via broadband, fiber optic, satellite, or other communication method, and are then encoded at the ingest and operations center 802. The appropriate encoding format, or multiple encoding formats, is selected according to the target networks' infrastructure that will ultimately be used to reach end-viewers 20c. For example, the encoding format and bit-rate would differ for broadcast to broadband computer-based viewers versus cell phone viewers. Consumable videos are made available in a format compatible with programs that synchronize high-quality music, video, and photos to device that receives broadband technology, for example, the Windows Media Player platform. Off-the-shelf encoders at the production studio 702 are used to create DRM encryption, using the event identification generated by the business server and established conventions.

The digital media broadcasting services are delivered as broadband TV, not “webcasting” (which as used herein refers to real-time streaming transmission of encoded video and/or audio under the control of a server to multiple recipients who all receive the same content at the same time). High quality feeds are delivered over a (VPN), a specially designed video-enabled delivery network that the DMBSP uses to provide TV-like quality to viewers 20c.

Feeds for all live and on-demand events are downlinked and encoded in the production studio 702 and distributed through a CDN. Consumable events (which are synonymous with video and content) include live events, events that were shown live and are still in the on-demand viewing period, and items in the Training Library. All events are manually ingested into the CDN with the appropriate URLs. The URLs for each event are generated by convention when an administrative user first approves the event in the User Interface. For each event, there is one URL for the live stream and another URL for the on-demand stream. All live streams must be activated exactly at the official start time. The on-demand stream is activated within two hours of the completion of the live event. A graphical message for the viewer 20c is displayed in a designated video i-frame (channel) indicating the imminent availability of the event “On-demand.”

Encoded master files are generated for all events. Storage of master files can be maintained external to the system in the production studio 702.

The production operation can scale to support unlimited simultaneous live events. There is also no limit on the number of events that can be simultaneously available on-demand.

There are two types of events, direct feed and events produced by the DMBSP 20b. For events received by the DMBSP via a direct feed, a DMBSP producer works with the media source 20a to determine if any changes will be made to the feed by the DMBSP. In either case, the producer has the option to add interstitials, such as advertisements or voice-overs, prior to transmission and encoding. For productions of the DMBSP 20b, all interstitials are inserted into the feed on-site at the event location via a manual process prior to uplink. The live and on-demand versions of an event have the same bumpers (that is, ads placed at either end of the video content—they precede or follow the video itself)and interstitials (that is, ads that are inserted throughout the body of the broadcast). Standard procedures can be used to brand events with graphics and scripts given to field production crews by the event producer or direct for introductions, commercial break-away/returns, score displays, end of the broadcast trailer, etc. For all “live” broadcasts, commercial/video advertisements can be manually inserted directly into the feed at the site of the event. All ads are inserted into the feed prior to transmission and encoding. A manual off-line process is used to manage available ad space per event and track the sales and scheduling of ads for each event.

For Direct Feed events, it is the responsibility of the media source (i.e. the production team responsible for producing the event and giving the feed to the DMBSP) to insert the ads at the site of the event. For field production by the DMBSP 20b, a producer for the DMBSP inserts the ads at the event site prior to transmission and encoding. The DMBSP production studio 702 can also centrally insert ads, logging, and other content.

In addition to the ads included in the video feed, there can be zero or more ads associated with each event to be displayed in portal “I-frames” external to the video stream. “I-frames” are collateral information and images that are displayed to viewers 20c while they are watching a video. Examples of what can be placed in the I-frames include advertisements (I-frame 10b), surveys (I-frame 10c), chat, team statistics 10d (I-frame 10d), etc. The content is displayed in frames next to the frame 10a playing the video, and is created via a manual process. Storage and retrieval of the content is ingested into the portal filesystem via the business server UI. The types of content files supported in the I-frames include html, gif, jpg, png, js, css, and swf.

I-frames can only be utilized on computers that support certain minimum requirements, such as requirements with respect to Internet browsers (for example, Internet Explorer) and media players (for example, Windows Media Player). These requirements are tested by the system when the viewer 20c accesses the website. In a preferred embodiment, there are two I-frames in the portal video view, plus one smaller label frame. All collateral content in the I-frames is pre-produced. This content is viewable during the entire broadcast. Ads placed in the I-frames can be hotlinked to their sponsor's website. One of the benefits of the I-frames is that they can be tailored to the specific viewer based on a viewer's profile. Viewers thus can be targeted by age group, sex, geographic location, or any other classification.

The process for creation of ads to be displayed in the portal I-frame is identified by the Production team. Ads to be displayed in the portal I-frame have URLs referenced by convention in the portal filesystem. Visual presentation of ads to be displayed in the portal I-frame is handled by templates defined by the Production Team. The process for loading I-frame content for events employs conventional web site design techniques that are well-known to those of ordinary skill in the art.

Viewers 20c can place new requests for specific, non-scheduled event broadcasts on a fee-per-event basis. Advertising fees are charged to businesses that want to advertise during a broadcast or set of related broadcasts. Additionally, the DMBSP receives commission and/or fees on all broadband subscriptions, mobile phone sales, and wireless monthly service fees generated via the DMBSP referrals.

In the service and method in accordance with the present invention, the advertising market is divided into four major categories: (1) content-related advertising; (2) audience-related advertising; (3) geographic-related advertising; and (4) general advertising.

As an example, assume the DMBSP 20b is streaming a women's soccer match. Examples of content related advertising are directly related services or merchandise like soccer gear or more indirectly related services or merchandise like sports drinks. Understanding that one large market segment likely to watch women's soccer is teenage girls, examples of audience related advertising would be a teenage magazine or new cosmetics. For a game being held in Richmond, Va., an example of a geographically related ad would be an ad for a local restaurant or perhaps the Virginia tourism board. An example of general advertising would be an ad for services or merchandise that is not targeted to the viewers.

The production process carried out by the DMBSP 20b includes all phases of production including but not limited to content development, location scouting, writing, producing, shooting video, editing, narration, music, graphics, transcription, captioning, and encryption. The content produced by the DMBSP itself includes live events and seminars broadcast via fiber or mobile satellite trucks, multi-camera broadcasts produced with package inserts, and promotional and corporate videos and documentaries.

The end product delivered to the viewer 20c consists of digital media streamed to a media viewer (for example, Windows Media Player) integrated into a portal front end along with various subcomponents such as team scores, player statistics, and a survey. Viewer 20cs can also choose to receive a physical copy (DVD, VHS, etc.) of archived events.

At the front end, e-commerce is conducted through an online storefront 1002 (FIG. 5) that displays all inventory items that are currently available, available at a future time, or available for training use. If the viewer 20c is already registered, the top-level inventory page provides items of high marketing interest based on his or her profile. Each event includes pricing, blackout information, date and time, and live/on-demand status. Viewers 20c have the option of purchasing single events or package events. Some events will indicate a time when the item will no longer be available. Viewers 20c are able to search the events based on keywords or from a drop-down menu that allows searching by Sport and Date.

Based on their zip code (both as recorded in the viewers' profiles, and also in the billing address for their credit card, if that method of payment is used), viewers are tested for blackout restrictions before completing checkout. Viewers 20c also can perform a test of their system from the broadcast web site prior to completing checkout. When a viewer 20c makes a purchase, the viewer has the option of having payment data (including, but not limited to, credit card information) saved to a viewer profile. Also, when a viewer makes a purchase, the viewer is asked to verify that the purchase data and purchase price are correct. Promotional codes are accepted and deducted from the total price before the viewer's credit card is charged. The viewer's credit card is not charged if the transaction is aborted. Purchases are made via a “shopping cart” similar to conventional “shopping cart” systems on most e-commerce websites, allowing a viewer to add and subtract any number of purchases from his or her “cart” before finalizing the transaction.

Viewers 20c are able to create and edit their own accounts and register via the storefront. They can also login via storefront with existing viewer ID and password. Both anonymous viewers and viewers who have registered and signed-in have the ability to browse/search all inventory. However, anonymous viewers are prompted to register/sign-in when proceeding to finalize their order. The interface will allow a viewer to register by entering an e-mail address, user ID, zip code, and password. Upon making a purchase, viewers will enter addition data including their address and credit card information (if required). The viewer will also have the ability to enter certain preferences, such as time zone and browsing format.

The storefront 1002 tracks all purchases made by the viewer and displays them in a “My Tickets” section or window. The “My Tickets” section also keeps track of all events that are placed on hold by a viewer.

The customer service contact number is visible on every page. When a viewer selects the customer service link (which can be displayed as a tab), the viewer is presented with a new window containing customer service information and links to create a trouble ticket.

The broadcast website includes conventional change password functionality and forgotten password functionality.

At the back-end, the system supports multiple levels of access in connection with groups, administrators, reporting, promotions, support, and inventory. Back-end access into the e-commerce application is provided to the DMBSP administrators and support staff.

A system administrator has the ability to add new groups with a role and group name, view all groups, and perform edits and deletes on groups; and also has the ability to add new administrators, view all administrators, perform edits and deletes on administrators, sort/filter by group name and viewer name, and drag column headers to appropriate location to be grouped.

The system administrator also has access to user administration options via the OMS UI. Operations supported by the administrative interface will include user administration, view order history, view profile, the OMS trouble ticket administration system, e-commerce reporting, entering promotions and generating promotion codes, and controlling viewer and system level settings. The system will also allow administrators or customer service representatives to override a blackout or credit a viewer account.

The e-commerce reporting system will provide a number of reports to administrators, including: Order History By Details, By Payment Type, By Group, By Category, By Demographics (Age, Gender, Location), Income Level, Family vs. Individual Item Activity, By Price, and By Order; Top Selling SKUs By City, By State, By Customer, and By Sale Price; Order Counts By City, By State, By Country, and By Customer; All Customers; Processing Charges; Unfulfilled Orders; Inventory Replenishment; Inventory Realtime Status; Events by Customer; View Cupon Usage History; and Digital Inventory Fulfilled.

The system also provides for administration of promotions, support, and inventory. Administrators have the ability to create a new promotion; assign promotions to a particular role, group, or event purchaser; view and edit all future promotions; and view all past promotions. They also can create new trouble tickets as well as view and edit all open and closed trouble tickets. Further, administrators can view all inventory; add new inventory; edit existing inventory; view all coupons; add new coupons; edit existing coupons; change an event end time (including during the event, itself); view and edit modifiers; view and add unit type; and view all, edit, and add categories.

Customer Service is responsible for ensuring that administrators have: the authority to override blackout restrictions, back-end privileges, the ability to create and edit trouble tickets, the ability to view order history, the ability to credit accounts; and for testing that phone, fax, e-mail, and chat are answered by Viewer Service.

Modifications and variations of the above-described embodiments of the present invention are possible, as appreciated by those skilled in the art in light of the above teachings. It is therefore to be understood that, within the scope of the appended claims and their equivalents, the invention may be practiced otherwise than as specifically described.

What is claimed is:

1. A method of unlimited channel broadcasting to devices that receive broadband technology from last mile service providers, comprising the steps of:
acquiring content;
encoding the content for distribution through a content delivery network as multi-frame content, in at least one format selected according to the infrastructure of the head end of the last mile service providers that will be used to reach the devices that receive broadband technology;
directly injecting the multi-frame content into the infrastructure of the head-end of the at least one last-mile service provider; and
distributing the multi-frame content from the at least one last-mile service provider to the devices according to personal preferences of end-viewers using the devices.

2. The method of claim 1, wherein the content corresponds to an event.

3. The method of claim 1, wherein the content is acquired as raw content, and wherein the method further comprises the steps of:
transmitting the raw content to an ingest and operations center, following the step of acquiring the content;
ingesting the transmitted content at the ingest and operations center; and
organizing and segregating the ingested content according to end-viewers' profiles, prior to encoding the content.

4. The method of claim 1, wherein the multi-frame content includes main content to be displayed in a main frame as streaming video and collateral content to be displayed in at least one portlet adjacent to the main frame.

5. The method of claim 1, wherein content comprises at least one of a live event, an event recorded for on-demand viewing, a documentary recorded for on-demand viewing.

6. Apparatus for unlimited channel broadcasting to devices that receive broadband technology from last mile service providers, comprising:
means for acquiring content;
means for encoding the content for distribution through a content delivery network as multi-frame content, in at least one format selected according to the infrastructure of the head end of the last mile service providers that will be used to reach the devices that receive broadband technology;
means for directly injecting the multi-frame content into the infrastructure of the head-end of the at least one last-mile service provider; and
means for distributing the multi-frame content from the at least one last-mile service provider to the devices according to personal preferences of end-viewers using the devices.

7. The apparatus of claim 6, wherein the content is acquired as raw content, and wherein the apparatus further comprises:
means for transmitting the raw content to an ingest and operations center;
means for ingesting the transmitted content at the ingest and operations center; and
means for organizing and segregating the ingested content according to end-viewers' profiles, prior to distribution by the means for distributing multi-frame content.

8. The apparatus of claim 6, wherein the content is acquired as an existing broadcast feed.

9. A method for creating an unlimited channel broadcast, comprising the steps of:
obtaining rights agreements from a media source for content to be broadcast;
providing after-market support to media sources and viewers having accounts;
acquiring the content;
transmitting the acquired content to a production studio;
editing the transmitted content at the production studio;
archiving, encoding, and encrypting the edited content for distribution to viewers;
distributing the encoded and encrypted content to viewers by at least one of streaming video and a storage medium; and
managing the viewer experience.

10. The method of claim 7, wherein the content corresponds to an event and in the acquiring step, the event is recorded as raw content, and wherein the method further comprises the steps of:
planning recording of the event in compliance with the rights agreements, prior to the acquiring step;
following the acquiring step, transmitting the recorded raw content to an ingest and operations center;
ingesting the transmitted content; and
organizing and segregating the ingested content according to end-viewers' profiles, prior to encoding the content.

11. The method of claim 7, wherein the step of providing after-market support includes enabling media sources and viewers to manage their accounts online.

12. The method of claim 7, wherein the step of archiving, encoding, and encrypting includes encoding the content for distribution through a content delivery network as multi-frame content, in at least one format selected according to the infrastructure of the head end of the last mile service providers that will be used to reach the devices that receive broadband technology.

13. The method of claim 7, wherein the step of providing after-market support includes providing media sources with online access to a computer-resident database of their rights agreements, and histories of broadcast content, purchases of content, and subscription to content.

14. The method of claim 7, wherein the step of providing after-market support includes enabling viewers to shop for, purchase, and track content.

15. The method of claim 7, wherein the editing step includes at least one of eliminating lulls, inserting header and trailer, inserting ads, overlaying graphics, overlaying scores, overlaying voice, and overlaying play-by-play commentary.

16. The method of claim 7, wherein the distributing step includes copying archived content to a storage medium and providing the storage medium to the viewer.

17. The method of claim 7, wherein the content is in the form of streaming video and the distributing step includes translating the video to an appropriate protocol and distributing it to virtual head-ends where the viewers' portals reside.
